(19) United States
(12) Patent Application Publication
(10) Pub. No.: US 2026/0249433 A1
(43) Pub. Date: Aug. 27, 2026

(54) ROTARY TOOL

(71) Applicant: YUNG-TSUNG CHANG, Taichung City (TW)

(72) Inventor: YUNG-TSUNG CHANG, Taichung City (TW)

(21) Appl. No.: 19/065,106

(22) Filed: Feb. 27, 2025

(51) Int. Cl. B25B 23/00

(52) U.S. Cl. CPC B25B 23/0028

(57) ABSTRACT

A rotary tool, including: a driving rod, a driven rod, and a transmission mechanism. The transmission mechanism includes a first pivot seat, a second pivot seat, a driving bevel gear, a driven bevel gear, and two transmission bevel gears. The first pivot seat and the second pivot seat are pivotally connected. The driving bevel gear is rotatably disposed on the first pivot seat and non-rotatably connected to the driving rod. The driven bevel gear is rotatably disposed on the second pivot seat and non-rotatably connected to the driven rod. The two transmission bevel gears are engaged between the driving bevel gear and the driven bevel gear. An elastic member is disposed between the first pivot seat and the driving bevel gear, and the elastic member urges the driving bevel gear to have a tendency to move in a direction toward the two transmission bevel gears.

### BACKGROUND OF THE INVENTION

### Field of the Invention

The present invention relates to a rotary tool.

### Description of the Prior Art

Rotary tools, such as screwdrivers, tool shafts, etc., are designed to fasten or release fasteners. Some of these rotary tools are steerable, allowing the handle and the working end to be adjusted relative to each other, making them convenient for fastening operations in various working environments.

However, the existing steerable rotary tools have complex structures, are difficult to manufacture, leading to higher costs. They are also prone to failures or wear of components during use, resulting in poor torque transmission, operational stability, and smoothness.

The present invention is, therefore, arisen to obviate or at least mitigate the above-mentioned disadvantages.

### SUMMARY OF THE INVENTION

The main object of the present invention is to provide a rotary tool, which is steerable, with a simple structure and stable, smooth operation.

To achieve the above and other objects, the present invention provides a rotary tool, including: a driving rod, a driven rod and a transmission mechanism. The driven rod is configured to be non-rotatably assembled with a workpiece to be rotated. The transmission mechanism includes a first pivot seat, a second pivot seat, a driving bevel gear, a driven bevel gear and two transmission bevel gears. The first pivot seat and the second pivot seat are pivotally connected with each other, the driving bevel gear is rotatably disposed on the first pivot seat and non-rotatably connected to the driving rod, and the driven bevel gear is rotatably disposed on the second pivot seat and non-rotatably connected to the driven rod. The two transmission bevel gears are engaged between the driving bevel gear and the driven bevel gear. An elastic member is disposed between the first pivot seat and the driving bevel gear, and the elastic member urges the driving bevel gear to have a tendency to move in a direction toward the two transmission bevel gears. When the elastic member is compressed and the driving bevel gear is disengaged from the two transmission bevel gears, the first pivot seat and the second pivot seat are pivotable relative to each other to adjust an angle therebetween.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferable embodiment of the present invention;

FIG. 2 is a breakdown drawing of a preferable embodiment of the present invention;

FIG. 3 is a partial cross-sectional view of a preferable embodiment of the present invention; and

FIG. 4 is a drawing showing operation of a preferable embodiment of the present invention.

### DETAILED DESCRIPTION OF THE PREFERRED EMBODIMENTS

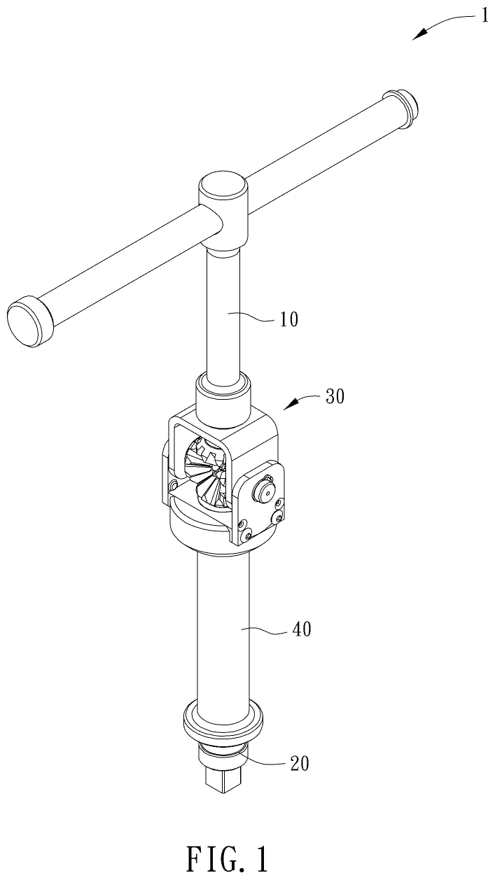

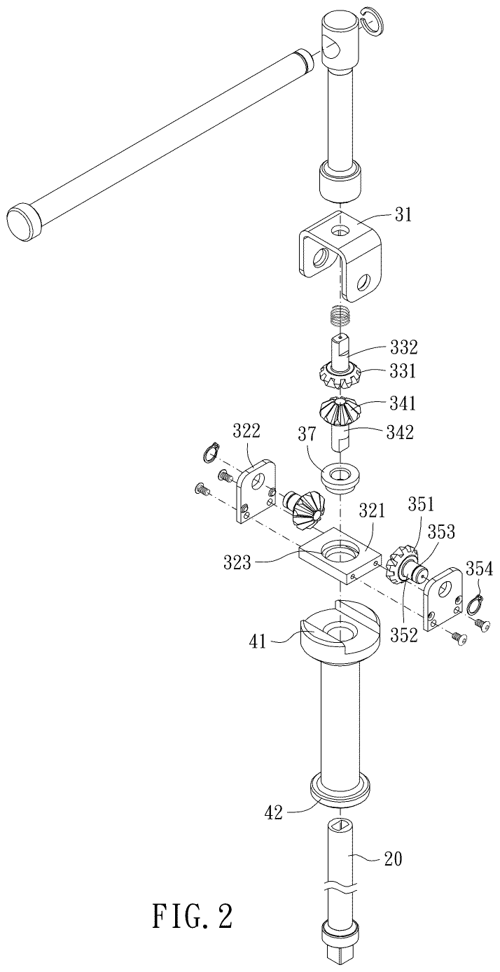

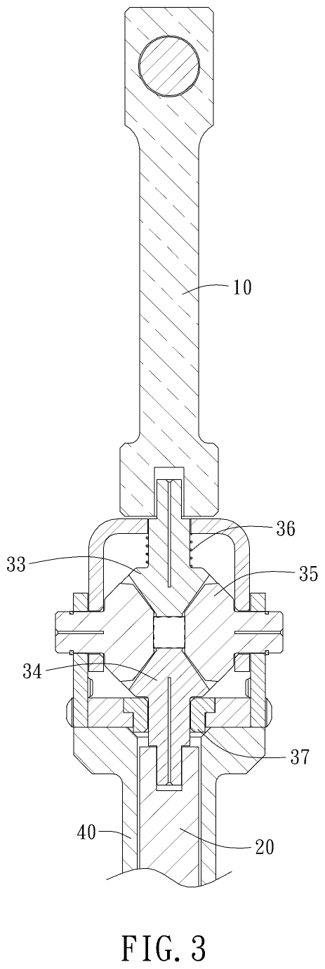

Please refer to FIGS. 1 to 4 for a preferable embodiment of the present invention. A rotary tool 1 of the present invention includes a driving rod 10, a driven rod 20 and a transmission mechanism 30.

The driven rod 20 is configured to be non-rotatably assembled with a workpiece to be rotated. The transmission mechanism 30 includes a first pivot seat 31, a second pivot seat 32, a driving bevel gear 33, a driven bevel gear 34 and two transmission bevel gears 35. The first pivot seat 31 and the second pivot seat 32 are pivotally connected with each other, the driving bevel gear 33 is rotatably disposed on the first pivot seat 31 and non-rotatably connected to the driving rod 10, and the driven bevel gear 34 is rotatably disposed on the second pivot seat 32 and non-rotatably connected to the driven rod 20. The two transmission bevel gears 35 are engaged between the driving bevel gear 33 and the driven bevel gear 34. An elastic member 36 is disposed between the first pivot seat 31 and the driving bevel gear 33, and the elastic member 36 urges the driving bevel gear 33 to have a tendency to move in a direction toward the two transmission bevel gears 35. When the elastic member 36 is compressed and the driving bevel gear 33 is disengaged from the two transmission bevel gears 35, the first pivot seat 31 and the second pivot seat 32 are pivotable relative to each other to adjust an angle therebetween. Therefore, an angle between the driving rod 10 and the driven rod 20 is adjustable to meet different requirements.

The driving bevel gear 33 includes a driving toothed portion 331 and a driving shaft portion 332, the elastic member 36 is elastically abutted against and between a side of the first pivot seat 31 and the driving toothed portion 331, and the driving shaft portion 332 protrudes beyond another side of the first pivot seat 31 and is detachably connected with the driving rod 10, which is convenient to replace the driving rod 10 with one of the required size or type. The driven bevel gear 34 includes a driven toothed portion 341 and a driven shaft portion 342, and the driven shaft portion 342 protrudes beyond a side of the second pivot seat 32 remote from the driving bevel gear 33 and is detachably connected with the driven rod 20. Therefore, the driven rod 20 is replaceable with different types or sizes to be connected with tool heads such as screwdriver heads, screws, nuts, sockets, etc., allowing for a wide range of applications. Specifically, a connection between the driving shaft portion 332 and the driving rod 10, and a connection between the driven shaft portion 342 and the driven rod 20 may be provided by existing structures such as pins, fastening components, or positioning steel balls.

In this embodiment, the second pivot seat 32 includes a middle plate 321 and two side plates 322, the driven bevel gear 34 penetrates through the middle plate 321, and the two side plates 322 are detachably assembled to the middle plate 321 for easy assembling. The first pivot seat 31 is arranged between the two side plates 322. Each of the two transmission bevel gears 35 includes a transmission toothed portion 351 and a transmission shaft portion 352, said transmission shaft portions 352 of the two transmission bevel gears 35 are coaxially arranged. Each said transmission shaft portion 352 penetratingly connects the first pivot seat 31 with the second pivot seat 32. Specifically, an engaging groove 353 of each said transmission shaft portion 352 has a retainer 354 engaged therewithin to restrict the two transmission bevel gears 35 to the second pivot seat 32. Therefore, the first pivot seat 31 and the second pivot seat 32 are smoothly swingable relative to each other to adjust the angle, and are easy to assemble. Tooth counts of the driving toothed portion 331, the driven toothed portion 341 and the transmission toothed portion 351 are identical, ensuring stable meshing and reliable torque transmission. In other embodiments, the tooth counts of the driving toothed portion, the driven toothed portion and the transmission toothed portion may be different.

Preferably, the transmission mechanism 30 further includes a bushing 37, and the second pivot seat 32 has an annular stepped portion 323 disposed thereon. The bushing 37 is engaged within the annular stepped portion 323, and the bushing 37 surrounds and is abuttable against the driven bevel gear 34. The bushing 37 may be selected to have lower friction resistance than the driven bevel gear 34, to avoid direct contact and friction resistance between the driven bevel gear 34 and the second pivot seat 32, ensuring that the driven bevel gear 34 is smoothly driven. One of the first pivot seat 31 and the second pivot seat 32 has at least one blocking portion 324, and the at least one blocking portion 324 is interferingly blockable with the other of the first pivot seat 31 and the second pivot seat 32. For example, each of the two side plates 322 has one said blocking portion 324 which is interferingly blockable with the first pivot seat 31 to restrict a pivot angle between the first pivot seat 31 and the second pivot seat 32 to avoid over-swinging.

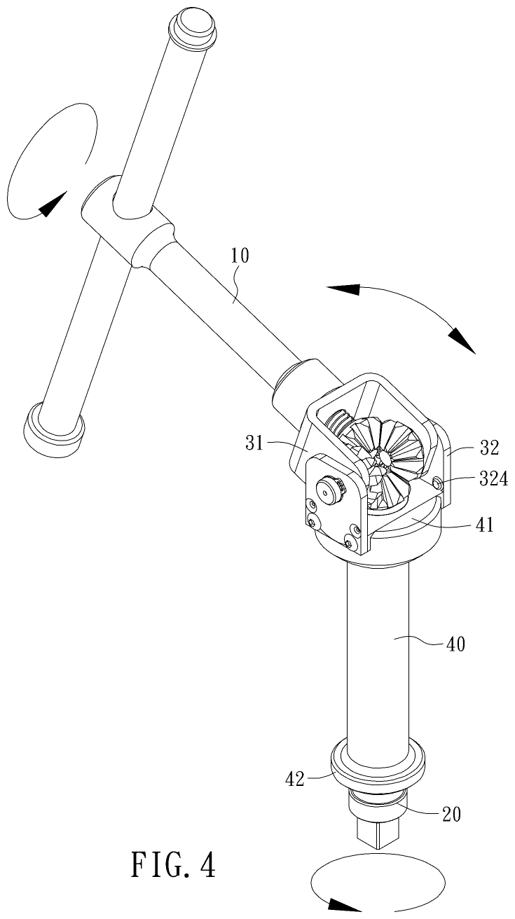

Please refer to FIG. 4. In operation, the driving rod 10 is pulled toward a side remote from the transmission mechanism 30, which drives the driving bevel gear 33 to compress the elastic member 36 and disengage from the two transmission bevel gears 35. As a result, the first pivot seat 31 and the second pivot seat 32 are pivotable relative to each other. When the angle between the driving rod 10 and the driven rod 20 is adjusted to a predetermined degree, the driving rod 10 is released, and the elastic member 36 urges the driving bevel gear 33 to move toward and engage with the two transmission bevel gears 35. The rotary tool 1 has a simple structure, is easy to operate, and provides stable and smooth operation. The driving rod 10 may be rotated manually or by a power tool to drive the driving bevel gear 33, the two transmission bevel gears 35 and the driven bevel gear 34 to rotate, thereby transmitting torque to achieve the purpose of fastening operations.

Moreover, the rotary tool 1 further includes a sleeve member 40, and the sleeve member 40 is sleeved to an outer periphery of the driven rod 20 and includes an engaging head portion 41. The engaging head portion 41 is non-rotatably engaged with the second pivot seat 32, and the driven rod 20 protrudes beyond a side of the sleeve member 40 opposite to the engaging head portion 41 so that an operator can hold the sleeve member 40 for stable operation. The side of the sleeve member 40 opposite to the engaging head portion 41 has a radial flange 42 disposed thereon so as to prevent the operator's hand from accidentally moving onto the driven rod 20, ensuring good operational safety. An inner circumferential surface of the sleeve member 40 and an outer circumferential surface of the driven rod 20 have an interval therebetween so that the driven rod 20 can be rotated smoothly.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A rotary tool, including:
a driving rod;
a driven rod, configured to be non-rotatably assembled with a workpiece to be rotated; and
a transmission mechanism, including a first pivot seat, a second pivot seat, a driving bevel gear, a driven bevel gear and two transmission bevel gears, the first pivot seat and the second pivot seat pivotally connected with each other, the driving bevel gear rotatably disposed on the first pivot seat and non-rotatably connected to the driving rod, the driven bevel gear rotatably disposed on the second pivot seat and non-rotatably connected to the driven rod, the two transmission bevel gears engaged between the driving bevel gear and the driven bevel gear;
wherein an elastic member is disposed between the first pivot seat and the driving bevel gear, and the elastic member urges the driving bevel gear to have a tendency to move in a direction toward the two transmission bevel gears; when the elastic member is compressed and the driving bevel gear is disengaged from the two transmission bevel gears, the first pivot seat and the second pivot seat are pivotable relative to each other to adjust an angle therebetween.

2. The rotary tool of claim 1, wherein the driving bevel gear includes a driving toothed portion and a driving shaft portion, the elastic member is elastically abutted against and between a side of the first pivot seat and the driving toothed portion, and the driving shaft portion protrudes beyond another side of the first pivot seat and is detachably connected with the driving rod.

3. The rotary tool of claim 1, wherein the driven bevel gear includes a driven toothed portion and a driven shaft portion, and the driven shaft portion protrudes beyond a side of the second pivot seat remote from the driving bevel gear and is detachably connected with the driven rod.

4. The rotary tool of claim 1, wherein each of the two transmission bevel gears includes a transmission toothed portion and a transmission shaft portion, the two transmission bevel gears are coaxially arranged, and the transmission shaft portion of each of the two transmission bevel gears penetratingly connects the first pivot seat with the second pivot seat.

5. The rotary tool of claim 1, further including a sleeve member, wherein the sleeve member is sleeved to an outer periphery of the driven rod and includes an engaging head portion, the engaging head portion is non-rotatably engaged with the second pivot seat, and the driven rod protrudes beyond a side of the sleeve member opposite to the engaging head portion.

6. The rotary tool of claim 5, wherein the side of the sleeve member opposite to the engaging head portion has a radial flange disposed thereon, and an inner circumferential surface of the sleeve member and an outer circumferential surface of the driven rod have an interval therebetween.

7. The rotary tool of claim 1, wherein the transmission mechanism further includes a bushing, the second pivot seat has an annular stepped portion disposed thereon, the bushing is engaged within the annular stepped portion, and the bushing surrounds and is abuttable against the driven bevel gear.

8. The rotary tool of claim 1, wherein one of the first pivot seat and the second pivot seat has at least one blocking portion, and the at least one blocking portion is interferingly blockable with the other of the first pivot seat and the second pivot seat.

9. The rotary tool of claim 1, wherein the second pivot seat includes a middle plate and two side plates, the driven bevel gear penetrates through the middle plate, and the two side plates are detachably assembled to the middle plate.

10. The rotary tool of claim 6, wherein the driving bevel gear includes a driving toothed portion and a driving shaft portion, the elastic member is elastically abutted against and between a side of the first pivot seat and the driving toothed portion, and the driving shaft portion protrudes beyond another side of the first pivot seat and is detachably connected with the driving rod; the driven bevel gear includes a driven toothed portion and a driven shaft portion, the driven shaft portion protrudes beyond a side of the second pivot seat remote from the driving bevel gear and is detachably connected with the driven rod; each of the two transmission bevel gears includes a transmission toothed portion and a transmission shaft portion, the two transmission bevel gears are coaxially arranged, and the transmission shaft portion of each of the two transmission bevel gears penetratingly connects the first pivot seat with the second pivot seat, and an engaging groove of each said transmission shaft portion has a retainer engaged therewithin to restrict the two transmission bevel gears to the second pivot seat; tooth counts of the driving toothed portion, the driven toothed portion and the transmission toothed portion are identical; the transmission mechanism further includes a bushing, the second pivot seat has an annular stepped portion disposed thereon, the bushing is engaged within the annular stepped portion, and the bushing surrounds and is abuttable against the driven bevel gear; the second pivot seat includes a middle plate and two side plates, and the driven bevel gear penetrates through the middle plate, and the two side plates are detachably assembled to the middle plate; the first pivot seat is arranged between the two side plates; and each of the two side plates has a blocking portion which is interferingly blockable with the first pivot seat to restrict a pivot angle between the first pivot seat and the second pivot seat.
